(19) United States
(12) Patent Application Publication
(10) Pub. No.: US 2025/0334293 A1
(43) Pub. Date: Oct. 30, 2025

(54) AIR CONDITIONER AND CONTROL METHOD THEREOF

(71) Applicant: Samsung Electronics Co., Ltd., Suwon-si (KR)

(72) Inventors: Mingu JEON, Suwon-si (KR); Hyunho KIM, Suwon-si (KR); Seonmi KIM, Suwon-si (KR); Byungyul SO, Suwon-si (KR); Byeongkook YOO, Suwon-si (KR); Changwoo JUNG, Suwon-si (KR)

(21) Appl. No.: 19/091,147

(22) Filed: Mar. 26, 2025

Related U.S. Application Data
(63) Continuation of application No. PCT/KR2025/001725, filed on Feb. 5, 2025.

(30) Foreign Application Priority Data
Apr. 26, 2024 (KR) 10-2024-0056079
Jul. 10, 2024 (KR) 10-2024-0091373

(51) Int. Cl. F24F 11/79

(52) U.S. Cl. CPC F24F 11/79

(57) ABSTRACT

A ceiling-mounted air conditioner is provided. The ceiling-mounted air conditioner includes a cabinet, a panel disposed at one surface of the cabinet, and a sensing part disposed at an inner side of the panel. The sensing part includes a sensor configured to sense an object positioned outside of the panel, and a case for receiving the sensor. The case includes a support part supporting the sensor for the sensor to perform sensing in a direction inclined at a pre-set angle with respect to the panel, and a cover part covering the sensor by coupling with the support part.

### CROSS-REFERENCE TO RELATED APPLICATION(S)

This application is a continuation application, claiming priority under § 365 (c), of an International application No. PCT/KR2025/001725, filed on Feb. 5, 2025, which is based on and claims the benefit of a Korean patent application number 10-2024-0056079, filed on Apr. 26, 2024, in the Korean Intellectual Property Office, and a Korean patent application number 10-2024-0091373, filed on Jul. 10, 2024, in the Korean Intellectual Property Office, the disclosure of each of which is incorporated by reference herein in its entirety.

### BACKGROUND

### 1. Field

The disclosure relates to an air conditioner. More particularly, the disclosure relates to an air conditioner including a sensor which senses object and a control method thereof.

### 2. Description of Related Art

An air conditioner may be a device for adjusting temperature, humidity, airflow and distribution, and the like suitable to human activity, and is configured with a compressor, a condenser, an evaporator, a blowing fan, and the like.

Recently, in order to raise efficiency in air conditioners, object sensing sensors have been introduced.

As an example, an object sensing sensor of a passive infrared sensor (PIR) type has been used in air conditioners. However, because the PIR sensor has to be protruded outwards to perform a sensing function, air conditioners attached with PIR sensors incurred aesthetic problems. Specifically, with a 4-way cassette type air conditioner, four or more sensors for sensing occupancy of a whole space and controlling airflow had to be connected in a complex manner. Accordingly, problems occurred aesthetically as protruded portions of the sensors increased.

In addition, with a ceiling-mounted air conditioner, a sensor is disposed vertically from the panel. Based on the above, there has been a problem of object sensing efficiency of the sensor deteriorating.

Aspects of the disclosure are to address at least the above-mentioned problems and/or disadvantages and to provide at least the advantages described below. Accordingly, an aspect of the disclosure is to provide an air conditioner including a sensor which senses object and a control method thereof.

Additional aspects will be set forth in part in the description which follows and, in part, will be apparent from the description, or may be learned by practice of the presented embodiments.

The above information is presented as background information only to assist with an understanding of the disclosure. No determination has been made, and no assertion is made, as to whether any of the above might be applicable as prior art with regard to the disclosure.

### SUMMARY

In accordance with an aspect of the disclosure, a ceiling-mounted air conditioner is provided. The ceiling-mounter air conditioner includes a cabinet, a panel disposed at one surface of the cabinet, and a sensing part disposed at an inner side of the panel, the sensing part includes a sensor configured to sense an object positioned outside of the panel, and a case for receiving the sensor, and the case includes a support part supporting the sensor for the sensor to perform sensing in a direction inclined at a pre-set angle with respect to the panel, and a cover part covering the sensor by coupling with the support part.

In accordance with another aspect of the disclosure, a method performed by a ceiling-mounted air conditioner is provided. The method includes obtaining sensing data of a sensor disposed in a direction inclined at a pre-set angle from an inner side of a panel disposed at one surface of a cabinet of the ceiling-mounted air conditioner, and driving, based on the sensing data, the ceiling-mounted air conditioner when a moving object positioned outside of the panel is identified.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a configuration of a ceiling-mounted air conditioner according to an embodiment of the disclosure;

FIG. 2 is a diagram illustrating a refrigerant circuit of an air conditioning system according to an embodiment of the disclosure;

FIG. 3 is a perspective view of a ceiling-mounted air conditioner according to an embodiment of the disclosure;

FIG. 4 is a bottom view of a panel disposed at one surface of a ceiling-mounted air conditioner according to an embodiment of the disclosure;

FIG. 5 is a block diagram illustrating a ceiling-mounted air conditioner according to an embodiment of the disclosure;

FIG. 6 is an exploded view of a sensing part according to an embodiment of the disclosure;

FIG. 7 is a perspective view of a support part on which a sensor is seated according to an embodiment of the disclosure;

FIG. 8 is a diagram illustrating a cross-section of a support part coupled with a sensor according to an embodiment of the disclosure;

FIG. 9 is a diagram illustrating a cover part including an adjustment lever according to an embodiment of the disclosure;

FIGS. 10 and 11 are diagrams illustrating a cross-section of a case in FIG. 9 taken along line A-A′ according to various embodiments of the disclosure;

FIG. 12 is a diagram illustrating one surface of a 4-way type ceiling-mounted air conditioner according to an embodiment of the disclosure; and

FIG. 13 is a flowchart of a ceiling-mounted air conditioner according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

With respect to the description of the drawings, like reference numerals may be used to indicate like elements.

In the disclosure, phrases such as “A or B,” “at least one of A and B,” “at least one of A or B,” “A, B, or C”, “at least one of A, B, and C,” and “at least one of A, B, or C” may respectively include any one or all possible combinations of the items listed together with the relevant phrase from among the phrases.

The term “and/or” may include a combination of a plurality of related elements described or any element from among the plurality of related elements described.

Terms such as “1st”, “2nd”, or “first” or “second” may be used to simply distinguish a relevant element from another relevant element, and not limit the relevant elements in other aspects (e.g., importance or order).

When a certain (e.g., first) element is indicated as being “operatively” or “communicatively” “coupled with/to” or “connected to” another (e.g., second) element, it may be understood as the certain element being coupled with/to the another element directly (e.g., via wire), wirelessly, or as being coupled through a third element.

It is to be understood that the terms such as “have” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “connected” with/to, “coupled” with/to, “supported” by, or “contacted” by/to another element, the above may include not only instances of the elements being directly connected, coupled, supported, or contacted, but also include instances of the same being indirectly connected, coupled, supported, or contacted through the third element.

When the certain element is described as positioned “on” another element, the above may include not only the certain element being contacted to another element, but also other element being present between the two elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

A ceiling-mounted air conditioner according to various embodiments will be described in detail below with reference to the drawings.

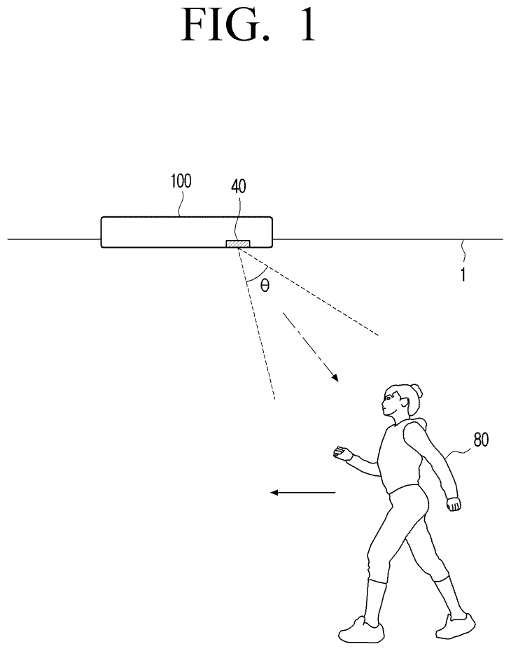

FIG. 1 is a diagram illustrating a configuration of a ceiling-mounted air conditioner 100 according to an embodiment of the disclosure.

Referring to FIG. 1, a ceiling-mounted air conditioner 100 may be disposed at a ceiling of an indoor space. In this case, a user 80 may walk at a lower side of the ceiling-mounted air conditioner 100.

The ceiling-mounted air conditioner 100 may include a sensing part 40 inside thereof, and sense movement of the user 80 based on sensing data of the sensing part 40.

Referring to FIG. 1, a sensing range of the sensing part 40 may be a state inclined at a pre-set angle range between a direction perpendicular from a lower side of a ceiling 1, and a direction parallel to the ceiling 1. In FIG. 1, a state inclined at a random inclination within 0 range is shown. In this case, the ceiling-mounted air conditioner 100 may identify in advance a movement of the user 80 before the user 80 moves to a position right under the ceiling-mounted air conditioner 100. Accordingly, cool air or warm air may be provided by driving the ceiling-mounted air conditioner 100 in advance. The ceiling-mounted air conditioner 100 may cooperate with an outdoor unit in order to provide cool air or warm air. The ceiling-mounted air conditioner 100 and the outdoor unit may be combined and referred to as an air conditioning system. Alternatively, the ceiling-mounted air conditioner 100 may be referred to as an indoor unit, and may be referred to as the ceiling-mounted air conditioner 100 including the indoor unit and the outdoor unit. For convenience of description below, the indoor unit may be described as the ceiling-mounted air conditioner 100 below.

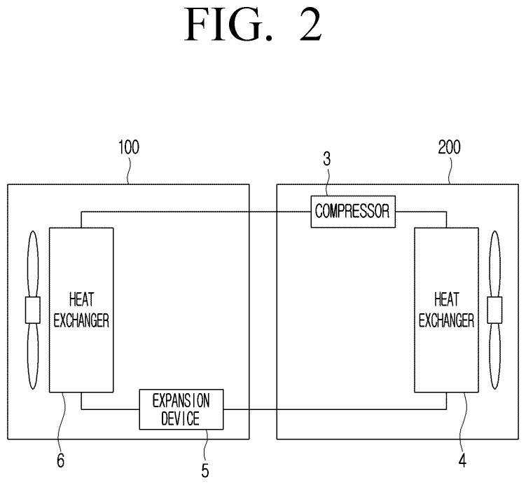

FIG. 2 is a diagram illustrating a configuration of an air conditioning system according to an embodiment of the disclosure.

Referring to FIG. 2, the air conditioning system may include an indoor unit 100 and an outdoor unit 200.

The indoor unit 100 may be positioned indoors in which air conditioning is to be performed. For example, the indoor unit 100 may be installed in a home or in an office. If implemented as the ceiling-mounted air conditioner 100, the indoor unit 100 may be installed in a ceiling of a home, in a ceiling of an office, or the like. If implemented as a stand type air conditioner, the indoor unit 100 may be installed by being manufactured in a structure that can be placed standing at a random position.

The outdoor unit 200 may be installed outdoors at which air conditioning is not performed.

According to one or more embodiments of the disclosure in FIG. 2, the outdoor unit 200 may be electrically connected with the indoor unit 100. For example, based on the user 80 inputting a command for turning-on the ceiling-mounted air conditioner 100 through an input interface or a remote controller provided in a main body of the indoor unit 100, the indoor unit 100 may transmit a turn-on command to the outdoor unit 200. Accordingly, the outdoor unit 200 and the indoor unit 100 may simultaneously or consecutively operate by responding to the user 80 command.

The indoor unit 100 may be divided into a ceiling-mounted indoor unit, a stand type indoor unit, a wall-mounted indoor unit, and the like according to a method in which the indoor unit 100 is disposed. If implemented as the ceiling-mounted indoor unit 100, the above may be divided into a 4-way type indoor unit, a 1-way type indoor unit, a duct type indoor unit, and the like according to a method in which air is discharged.

The air conditioning system of FIG. 2 may include a refrigerant circuit that circulates a refrigerant between indoors and outdoors. The refrigerant may circulate between the indoors and outdoors according to the refrigerant circuit, and absorb or discharge heat during a state change (e.g., state change from gas to liquid, state change from liquid to gas).

In order to induce a state change of the refrigerant, the refrigerant circuit may include a compressor 3, an outdoor heat exchanger 4, an expansion device 5, and an indoor heat exchanger 6.

Here, the expansion device 5 may be referred to, otherwise, as an expansion valve 5.

The compressor 3 may compress the refrigerant in a gaseous state to create a high-temperature, high-pressure gas refrigerant. The high-temperature/high-pressure gas refrigerant discharged from the compressor 3 may be introduced to the outdoor heat exchanger 4.

A fan may be provided in the vicinity of the outdoor heat exchanger 4. The fan may blow outdoor air to the heat exchanger to facilitate heat exchange between the refrigerant and outdoor air.

The high-temperature/high-pressure gas refrigerant from the outdoor heat exchanger 4 may become a refrigerant in liquid state by external air, and discharge heat. The refrigerant in liquid state discharged from the outdoor heat exchanger 4 may be introduced to the expansion device 5.

The expansion device 5 may lower pressure and temperature of the refrigerant in liquid state and create a low-temperature, low-pressure liquid refrigerant. The low-temperature/low-pressure liquid refrigerant discharged from the expansion valve 5 may be introduced to the indoor heat exchanger 6.

The low-temperature/low-pressure liquid refrigerant from the indoor heat exchanger 6 may evaporate to a gaseous state by absorbing heat from ambient warm air. The refrigerant in gaseous state discharged from the indoor heat exchanger 6 may be introduced to the compressor 3 and may circulated the refrigerant circuit again.

As described above, the refrigerant may emit heat from the outdoor heat exchanger 4, and absorb heat from the indoor heat exchanger 6. The indoor heat exchanger 6 may be installed in the indoor unit 100 together with the expansion valve 5, and the outdoor heat exchanger 4 may be installed in the outdoor unit 200 together with the compressor 3. Accordingly, the indoor heat exchanger 6 may cool the air indoors.

Likewise, the indoor heat exchanger 6 may perform heat exchange between the refrigerant and the indoor air by using a phase change (e.g., evaporation or condensation) of the refrigerant. For example, the refrigerant may absorb heat from indoor air while the refrigerant is evaporating from the indoor unit 100, and by blowing the cooled indoor air passing through the cooled indoor heat exchanger 6, the indoors may be cooled. In addition, while the refrigerant is condensed in the indoor heat exchanger 6, the refrigerant may emit heat with the indoor air, and by blowing the heated indoor air passing through the indoor heat exchanger 6 of a high-temperature, the indoors may be heated.

That is, the ceiling-mounted air conditioner 100 may perform a cooling function or a heating function through a phase change process of the refrigerant that circulates the outdoor heat exchanger 4 and the indoor heat exchanger 6, and the air conditioner may include the compressor 3 that compresses the refrigerant for the circulation of the refrigerant as described above. The compressor 3 may suction refrigerant gas through a suction part, and compress the refrigerant gas. The compressor 3 may discharge high-temperature, high-pressure refrigerant gas through a discharge part. The compressor 3 may be disposed inside the outdoor unit 200.

The refrigerant may circulate in an order of the compressor, the outdoor heat exchanger, the expansion device, and the indoor heat exchanger 6 through a refrigerant pipe, or circulate in an order of the compressor 3, the indoor heat exchanger 6, the expansion device 5, and the outdoor heat exchanger 4.

The outdoor unit 200 may not necessarily be used connected with one indoor unit 100, that is, one air conditioner 100, and may be used connected with a plurality of air conditioners 100.

If one outdoor unit 200 and one air conditioner 100 are directly connected through the refrigerant pipe, the refrigerant may be provided to circulate between one outdoor unit 200 and one air conditioner 100 through the refrigerant pipe.

In another example, if one outdoor unit 200 is connected with two or more ceiling-mounted air conditioners 100 through the refrigerant pipe, the refrigerant may flow to a plurality of indoor units 100 through the refrigerant pipe which is diverged from the outdoor unit 200. The refrigerant discharged from the plurality of indoor units 100 may be joined (or combined) and provided to be circulated to the outdoor unit 200. In an example, the plurality of indoor units 100 may be directly connected in parallel with one outdoor unit 200 through separate refrigerant pipes, respectively.

The plurality of indoor units 100 may be independently operated according to an operation mode set by each of the users. That is, a portion from among the plurality of indoor units 100 may be operated in a cooling mode, and simultaneously, another portion may be operated in a heating mode. At this time, the refrigerant may be introduced and discharged to each of the indoor units 100 in a selectively high-pressure or low-pressure state along a designated circulation path through a flow conversion valve which will be described below, and provided to be circulated to the outdoor unit 200.

In an example, the ceiling-mounted air conditioner 100 is configured such that when two or more outdoor units 200 and two or more indoor units 100 are connected through a plurality of refrigerant pipes, the refrigerant discharged from a plurality of outdoor units 200 may be joined flowing through one refrigerant pipe until the refrigerant is diverged again at a certain point and introduced to the plurality of indoor units 100.

The plurality of outdoor units 200 may all be driven or at least a portion thereof may not be driven based on a driving load according to a driving amount of the plurality of indoor units 100. At this time, the refrigerant may be provided to be circulated by being introduced to the outdoor unit 200 which is selectively driven through the flow conversion valve (not shown). The ceiling-mounted air conditioner 100 may include the expansion device 5 to lower pressure of the refrigerant that is introduced to the heat exchanger. In an example, the expansion device 5 may be disposed inside of the indoor unit 100 or inside of the outdoor unit 200, and may be disposed in both thereof.

The expansion device 5 may lower the temperature and pressure of the refrigerant using, for example, a throttling effect. The expansion device 5 may include an orifice (not shown) which can reduce a cross-sectional area of a flow path. The refrigerant that passed the orifice (not shown) may be lowered in temperature and pressure.

The expansion device 5 may be implemented, in an example, as an electronic expansion device which can adjust an opening ratio (a ratio of a cross-sectional area of a flow path of a valve in a partially opened state to a cross-sectional area of a flow path of a valve in a fully opened state). An amount of refrigerant that passes the expansion device 5 may be controlled depending on the opening ratio of the electronic expansion device.

The ceiling-mounted air conditioner 100 may further include the flow conversion valve (not shown) disposed on a refrigerant circulation flow path. The flow conversion valve (not shown) may include, for example, a 4-way valve. The flow conversion valve (not shown) may determine a circulation path of the refrigerant by depending on an operation mode (e.g., a cooling operation or a heating operation) of the indoor unit 100. The flow conversion valve (not shown) may be connected to a discharge part of the compressor 3.

The ceiling-mounted air conditioner 100 may include an accumulator (not shown). The accumulator (not shown) may be connected to a suction part of the compressor. In the accumulator (not shown), the low-temperature, low-pressure refrigerant evaporated from the indoor heat exchanger 6 or the outdoor heat exchanger 4 may be introduced.

The accumulator (not shown) may separate a refrigerant liquid from the refrigerant gas when a refrigerant mixed with the refrigerant liquid and the refrigerant gas is introduced, and provide the refrigerant liquid separated refrigerant gas to the compressor 3.

In FIG. 2, the ceiling-mounted air conditioner 100 of a structure in which air is discharged toward one way has been shown, but the discharge port may be implemented in plurality by two or more. For example, if configured in a 4-way, each discharge port may be provided in 4-ways perpendicular to one another with respect to a center of the panel of the ceiling-mounted air conditioner 100. The various embodiments of the disclosure may be applied to ceiling-mounted air conditioners 100 of various forms without limit to a number of discharge ports.

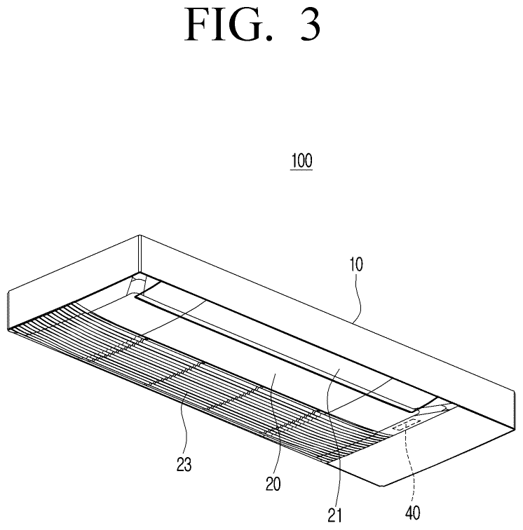

FIG. 3 is a perspective view of the ceiling-mounted air conditioner 100 according to an embodiment of the disclosure.

Referring to FIG. 3, the ceiling-mounted air conditioner 100 may include a cabinet 10, a panel 20 disposed at one surface of the cabinet 10, and the sensing part 40 disposed at an inner side of the panel 20.

The cabinet 10 may form an exterior of the ceiling-mounted air conditioner 100, and may be formed into a rectangular parallelepiped shape with approximately a length that is long and a width that is narrow. Because the ceiling-mounted air conditioner 100 is used buried in the ceiling, the exterior of the cabinet 10 may not be directly visible to the human eye after being buried. Although not shown in FIG. 3, the exterior of the cabinet 10 may be further included with at least one connection part to couple with or support a structure inside the ceiling.

In the disclosure, although it was been expressed as the cabinet 10, the cabinet 10 may be substituted with various expressions such as, a housing or a main body.

The panel 20 may be disposed at one surface of the cabinet 10. At a front surface of the panel 20, a discharge port 21 may be provided. The discharge port 21 may be formed for air to pass through, and may adjust a wind direction of cool air or warm air being discharged toward the indoors. Specifically, the discharge port 21 may be provided with an airflow guide that guides the direction of air being discharged. In an example, the airflow guide may include an auxiliary fan for adjusting discharged airflow. Not limited to the above, the airflow guide may be omitted. The discharge port 21 may be implemented in various forms such as a groove form, a hole form, or the like. If the ceiling-mounted air conditioner 100 of the disclosure is implemented as a windless type air conditioner, the discharge port 21 may be implemented with a plurality of micro holes. The windless type air conditioner may be an air conditioner of a form that cools an indoor space without causing direct wind by discharging cool air through the plurality of micro holes.

The panel 20 may be implemented in a form attachable to or detachable from one surface of the cabinet 10, and may be implemented integrated with the cabinet 10. In case of the windless type air conditioner, the panel 20 may be a windless panel including micro holes. In addition, the discharge port may be substituted with various expressions such as, for example, and without limitation, a discharging port, an emitting port, an outlet port, a windless hole, and the like.

Inside the cabinet of the ceiling-mounted air conditioner 100, the indoor heat exchanger 6 disposed on a flow path that connects a suction port 23 and the discharge port and a blower may be provided.

The blower (not shown) may include an indoor fan and a fan motor. As an example, the indoor fan may include an axial-flow fan, a mixed-flow fan, a cross-flow fan, and a centrifugal fan.

The indoor heat exchanger 6 may absorb heat from air introduced through the suction port 23, or transfer heat to air introduced through the suction port 23. The indoor heat exchanger 6 may include a heat exchange pipe through which the refrigerant flows inside thereof and a heat exchange pin which is in contact with the heat exchange pipe to increase a heat transfer area.

The ceiling-mounted air conditioner 100 may include a drain tray (not shown) which is disposed under the indoor heat exchanger 6 and collects condensation water generated from the indoor heat exchanger 6. The condensation water contained in the drain tray (not shown) may be drained to the outside through a water draining hose. The drain tray (not shown) may be provided to support the indoor heat exchanger 6.

The sensing part 40 may be disposed at the inner side of the panel 20, and sense an object positioned outside of the panel 20. Specifically, a human body may be identified, but is not necessarily limited thereto, and a sensor for sensing various moving bodies such as animals and robots may be used. The sensor may detect data values for sensing objects positioned outside of the panel 20, and may be formed to transmit the detected information to a processor through electrical signals. The sensor may mainly use a radar sensor. However, the sensor is not limited thereto, and may use various sensors such as, for example, and without limitation, a LiDAR sensor, an infrared ray (IR) sensor, an ultrasonic sensor, and the like.

The radar sensor may detect various data such as, for example, and without limitation, distance information, speed information, angle information, and the like of an object by using millimeter wave (mmWAVE) radio waves to pass through the panel 20. The processor may receive the detected information from the radar sensor. As described above, the object may mainly be a human body, but is not limited thereto, and various information such as distance information, speed information, angle information, and the like of various objects in addition to the human body may be detected.

The radar sensor may detect information of an object taking into consideration various elements such as transmitted power, a cross-section, received power, distance, and the like. When transmitted waves reach an object, a portion thereof may be reflected and returned to an antenna of a radar system, and the radar sensor may detect a distance and attribute of an object such as the human body through time and an intensity of the reflected signal described above.

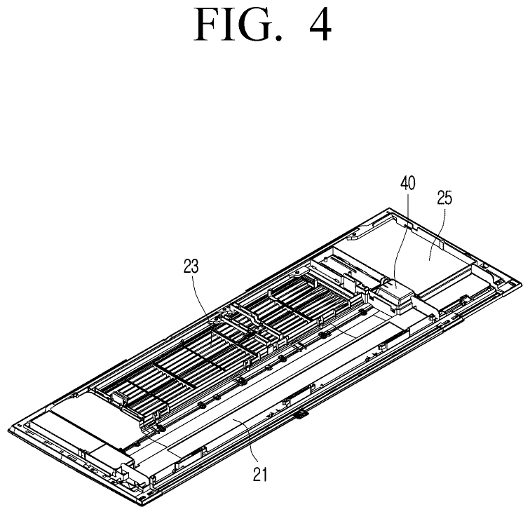

FIG. 4 is a bottom view of the panel 20 disposed at one surface of the ceiling-mounted air conditioner 100 according to an embodiment of the disclosure.

Referring to FIG. 4, the panel 20 may include the discharge port 21, the suction port 23, a cover part 25, and the sensing part 40.

Referring to FIG. 4, the suction port 23 may be positioned at a rear direction of a center part of the panel 20, and the discharge port 21 may be positioned at a front direction than the suction port 23 from the center part of the panel 20. The cover part 25 may be positioned at a left side part or a right side part from a bottom surface of the panel 20. Specifically, the cover part 25 may be disposed at a point spaced apart by a certain distance from a left side or a right side of the discharge port 21 and the suction port 23 from the bottom surface of the panel 20. The cover part 25 may protect a portion of the electronic devices inside the ceiling-mounted air conditioner 100.

Referring to FIG. 4, the sensing part 40 may be disposed at the inner side of the panel 20. In addition, the sensing part 40 may be disposed at a position adjacent with a side surface of the cover part 25 from among a space between the discharge port 21 and the suction port 23. Through the arrangement of the panel described above, the ceiling-mounted air conditioner 100 may prevent the sensing part from protruding from an outer side of the panel 20 and maintain a neat exterior. In addition, through the arrangement described above, the sensing part 40 may effectively sense the human body positioned outside of the panel 20. In addition, unlike that shown in FIG. 4, the sensing part 40 may be installed so as to be not visible from outside of the panel 20.

Referring to FIG. 4, the suction port 23 may draw in the indoor air to the inside of the ceiling-mounted air conditioner 100. The suctioned air may pass a filter in the ceiling-mounted air conditioner 100, and after dust or contaminants are removed, adjust the temperature by passing through a cooling coil (not shown) or a heating coil (not shown). Then, the processed air may be emitted back indoors through the discharge port 21 and adjust the temperature indoors and air quality.

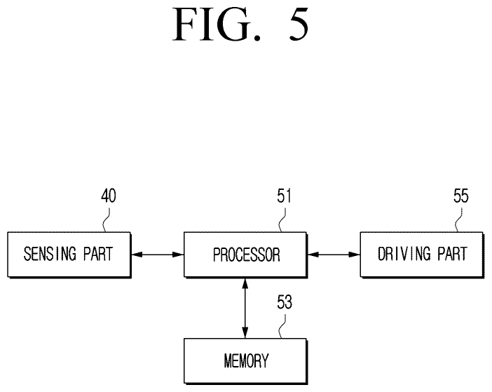

FIG. 5 is a block diagram illustrating the ceiling-mounted air conditioner 100 according to an embodiment of the disclosure.

Referring to FIG. 5, the ceiling-mounted air conditioner 100 may include memory 53 stored with at least one instruction, the sensing part 40, a processor 51, and a driving part 55.

The driving part 55 may be a configuration necessary in controlling the driving of the ceiling-mounted air conditioner 100. The driving part 55 may include the expansion device 5 and the heat exchanger 6 from among the configurations described above, but in order to perform air conditioning as described in FIG. 2, the above may be used together with a configuration of the outdoor unit 200 such as, for example, and without limitation, the compressor 3, the condenser (not shown), the evaporator (not shown), a plurality of fans motors (not shown), a plurality of fans (not shown), and the like.

The processor 51 may include a control circuit, and may be electrically connected with the memory 53 stored with at least one instruction, the sensing part 40, and the driving part 55. The processor 51 may perform various control operations by executing the at least one instruction stored in the memory 53.

The processor 51 may determine whether to drive based on sensing data sensed from the sensing part 40. Specifically, after transmitting a sensing signal from the sensing part 40 to the outside, if reflection signals (ultrasonic signals, radar signals, infrared ray signals, etc.) based therefrom are received, the processor 51 may determine whether an external object is present based on an amount, scale, received time, and the like of the reflection signal. The processor 51 may control, based on determining that there is an object (e.g., human body) moving from the outside to the direction of the ceiling-mounted air conditioner 100, the driving part 55 according to a pre-set user setting value. For example, if set for cool air to be provided when the user 80 passes by, the driving part 55 may be controlled to discharge low-temperature air.

The user setting value may include a setting value for the operation mode. In this case, the processor 51 may output, based on information detected through the sensor, a mode control signal for controlling the driving part 55 to operate in a pre-set operation mode.

For example, the processor 51 may control the ceiling-mounted air conditioner 100 for the ceiling-mounted air conditioner 100 to operate in any one operation mode from among a cooling operation mode, a dehumidifying operation mode, and a purifying operation mode based on the information detected through the sensor.

If the cooling operation mode is selected, the processor 51 may perform the cooling operation based on a target temperature and the indoor temperature. When performing the cooling operation, the processor 51 may operate the compressor 3 and the plurality of fans motors (not shown) from among the configurations of the driving part 55. The processor 51 may set the target temperature based on data detected through the sensor, and accordingly, a cooling control signal for operating the driving part 55 may be output.

If the cooling operation mode is selected, the processor 51 may control rotation speeds of the plurality of fans (not shown) from among the configurations of the driving part 55 differently from one another.

For example, if the cooling operation mode is selected, the processor 51 may set the rotation speeds of a portion of the fans from among the plurality of fans (not shown) to the highest speed, and control for the rotation speeds of another portion to become slower consecutively.

When performing the cooling operation, the air may be cooled by the refrigerant in the indoor heat exchanger 6, and when the air suctioned through the suction port 23 is contacted with the cooled indoor heat exchanger 6, moisture may be condensed at the surface of the heat exchanger 6. A portion of the moisture may move below along a surface of the indoor heat exchanger 6 and may be collected through a water collector.

If the dehumidifying operation mode of the ceiling-mounted air conditioner 100 is selected, the processor 51 may set a target humidity based on a sensing value detected through the sensor. Based therefrom, the processor 51 may adjust an indoor humidity by controlling the driving part 55.

If the purifying operation mode of the ceiling-mounted air conditioner 100 is selected, the processor 51 may purify the indoor air by operating the plurality of fans (not shown) and having the indoor air pass through the filter installed inside the cabinet 10. If the ceiling-mounted air conditioner 100 operates in the purifying operation mode, condensation water may not be generated at the indoor heat exchanger 6 because the compressor 3 is not operated.

In addition to the above, the processor 51 may output a control signal for controlling the driving part 55 based on programs, data, instructions, and the like stored in the memory 53.

The processor 51 may include a processing circuit, memory circuit, and a control circuit. The processor 51 may include at least one chip. In addition, the processor 51 may include at least one core.

The processor 51 may be implemented in various forms such as, for example, and without limitation, a central processing unit (CPU) or an application processor (AP), a digital signal processor (DSP), a microprocessor, micro controller unit (MCU), a micro processing unit (MPU), a neural processing unit (NPU), a controller, a timing controller (TCON), and the like.

The processor 51 may be implemented as a System on Chip (SoC) and a large scale integration (LSI), or may be implemented in a form of a field programmable gate array (FPGA).

The processor 51 may perform various operations using various programs, data, and instructions stored in the memory 53.

The memory 53 included with at least one instruction may store and/or call programs and/or data for processing information detected through the sensor. In addition, the memory 53 included with at least one instruction may store and/or call programs and/or data for controlling the driving part 55.

As described above, the memory 53 may be a configuration for storing various programs, data, instructions, and the like necessary in operating the ceiling-mounted air conditioner 100. The memory 53, like the processor 51, may be implemented with at least one or more, and a portion of the memories therefrom may be mounted in the processor 51, or implemented in a form of an external memory.

Specifically, the memory 53 may be implemented in various forms such as, for example, and without limitation a volatile memory (e.g., a dynamic RAM (DRAM), a static RAM (SRAM), or a synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard disk drive (HDD) or a solid state drive (SSD)).

The sensing part 40 may be a configuration for sensing an external state of the ceiling-mounted air conditioner 100.

In FIG. 1, because the ceiling-mounted air conditioner 100 having a one way discharge port has been shown, only one sensing part 40 toward the side of the discharge port thereof may be used. However, the embodiment is not limited thereto, and even if the one way discharge port 21 is used, the plurality of sensing parts 40 may be used. In addition, if implemented in a structure having a plurality of discharge ports 21, at least one sensing part 40 may be provided for each of the discharge ports.

The sensing part 40 may include at least one sensor. Here, the sensor may be various sensors such as, for example, and without limitation, a radar sensor, a LiDAR sensor, an infrared ray sensor, and the like.

The radar sensor may detect sensing data for obtaining distance information, speed information, and angle information.

As described above, the processor 51 may perform various control operations based on sensing data of the sensing part 40. Accordingly, sensing an approach of the user 80 in advance prior to the user 80 approaching directly next the ceiling-mounted air conditioner 100 may be advantageous. To this end, in the various embodiments of the disclosure, the sensing part 40 may be configured to form an inclined form within the pre-set angle range.

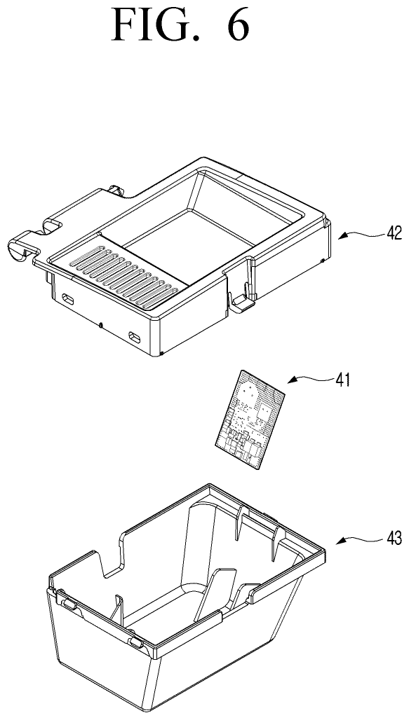

FIG. 6 is an exploded view of the sensing part 40 according to an embodiment of the disclosure.

Referring to FIG. 6, the sensing part 40 may include a sensor 41 for detecting information for sensing a human body positioned outside of the panel 20, and a case for receiving the sensor.

The case for receiving the sensor may include a support part 42 supporting the sensor 41 and a cover part 43 covering the sensor 41.

The case including the support part 42 and the cover part 43 may be of a plastic material. However, the embodiment is not limited thereto, and may be of various materials through which microwaves and the like transmitted from the sensor 41 may be transmitted.

The sensor 41 may be seated in the support part 42 in a state inclined at the pre-set angle with respect to the panel 20.

The sensor 41 may be various sensors such as the radar sensor, the infrared ray sensor, and the ultrasonic sensor which can transmit and detect data values even if all surfaces of the sensor is blocked by an object.

The radar sensor may discharge electromagnetic waves and the like and measure time until the wave is reflected by the human body and returned. Visibility of the radar sensor may effectively operate passing through materials with low visibility such as plastic. As shown in FIG. 5, the above may pass through the case, and detect data values with which the human body can be sensed by passing through the panel 20 shown in FIGS. 3 and 4.

The infrared ray sensor may detect data values sensing heat of an object using light of infrared rays. Because the infrared ray sensor may pass through various objects such as plastic and glass, data values with which the human body can be sensed may be detected by passing through the case and the panel 20.

The ultrasonic sensor may discharge sound waves and measure time until the wave is reflected by an object and returned. The ultrasonic waves may not only pass through air and liquid, but also some solid matters. Accordingly, the ultrasonic sensor may detect data values with which the human body can be sensed by passing through the case and the panel 20.

The support part 42 and the cover part 43 may receive the sensor 41 and protect the sensor 41 from various external elements such as heat, wind, dust, and the like inside the ceiling-mounted air conditioner 100.

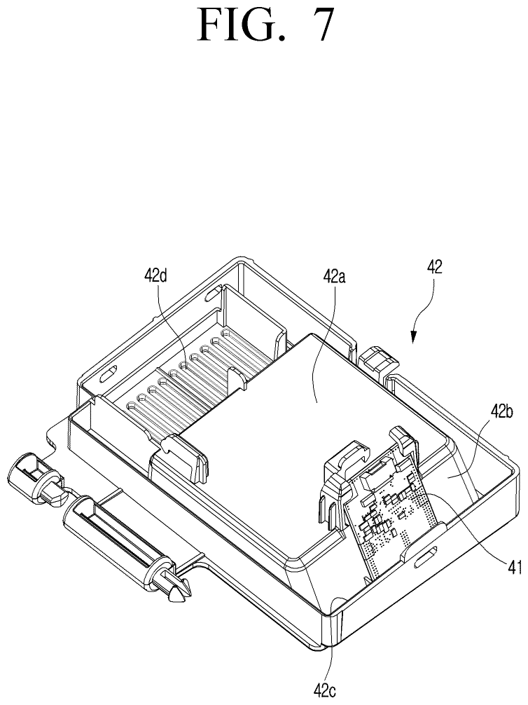

FIG. 7 is a diagram illustrating a cross-section of the support part 42 coupled with the sensor 41 according to an embodiment of the disclosure.

FIG. 7 is a cross-section taken of the support part 42 in which the sensor 41 is seated according to one or more embodiments of the disclosure.

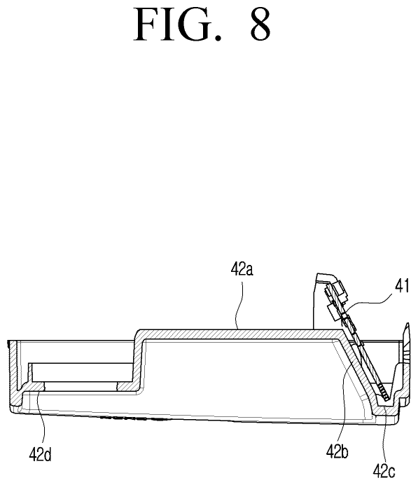

The support part 42 of FIG. 7 may show a form in which an upper and lower relationship of the support part 42 in FIG. 6 is reversed. Referring to FIG. 7 and FIG. 8, the support part 42 may be configured with a first bottom surface 42a, a seating surface 42b, a second bottom surface 42c, and a third bottom surface 42d. Specifically, the first bottom surface 42a may be disposed to be parallel with respect to the panel 20 from a center part of the support part. The seating surface 42b may be inclined at the pre-set angle from the first bottom surface 42a toward one side thereof. The pre-set angle may be parallel with the sensor 41. If the sensor 41 and the seating surface 42b are in parallel, diffraction of electromagnetic waves emitted from the sensor may be reduced, and accuracy may be raised. Specifically, if the diffraction is reduced, a phenomenon of waves bending at an edge of the seating surface may be reduced, and the sensor 41 may capture more clear and accurate information.

The second bottom surface 42c may be disposed protruded from the seating surface 42b. The second bottom surface 42c may support the sensor 41. In addition, the sensor 41 may be seated at the seating surface 42b while supported by the second bottom surface 42c.

The second bottom surface 42c may raise safety of the sensor 41 by supporting the sensor 41 and the seating surface 42b.

The third bottom surface 42d may be formed at a height different from that of the first bottom surface 42a and the second bottom surface 42c from an opposite side of the second bottom surface 42c with respect to the first bottom surface 42a.

The third bottom surface 42d may be formed in a slot form. Accordingly, the third bottom surface 42d may pass through between the inside and outside of the case through a slot portion.

In the inside space of the slot portion, a dust sensor (not shown) may be included. The dust sensor (not shown) may detect a dust level in air in data value. In addition, a degree of contamination of an air filter may be measured.

Although not shown in FIG. 5, the processor 51 may receive a transmission of data values detected through the dust sensor (not shown), continuously monitor the dust levels in air, and notify the user of a time-point at which a substitution or cleaning of the filter is needed. In addition, the processor 51 may receive transmission of data values detected through the dust sensor (not shown), and automatically adjust a plurality of fan speeds.

FIG. 8 is a diagram illustrating a cross-section of a support part coupled with a sensor according to an embodiment of the disclosure.

Referring to FIG. 8, the seating surface 42b may be configured in a form protruded to an upper side further than the first bottom surface 42a.

The sensor 41 may include a transmitter, an antenna, and a receiver.

In the radar sensor, the transmitter may perform a role of generating and discharging electromagnetic waves, and the antenna may emit the transmitted signal to a space, and receive the signal reflected by an object and returned. The receiver may receive and sense the reflected radar signal. In addition, if the signal received at the receiver is weak, the receiver may perform a function of amplifying the above and converting to useful data.

According to one or more embodiments of the disclosure in FIG. 8, the first bottom surface 42a may be formed in a parallel structure with respect to the panel 20. The structure as described may prevent diffraction of electronic waves transmitted by the sensor 41.

In FIG. 8, an angle of the seating surface that supports the sensor 41 may be any one from among an angle range of 60°±20° with respect to the panel 20. Because the sensor 41 is placed on the seating surface, the angle of the seating surface may become a sensing angle of the sensor 41.

The sensing angle of the sensor 41 may be manually or automatically adjustable.

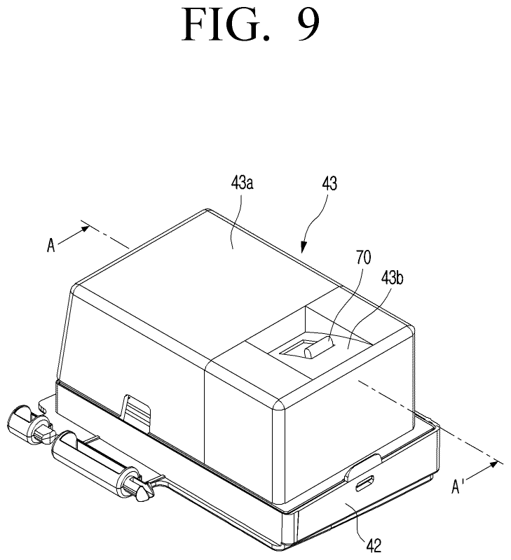

FIG. 9 is a diagram illustrating a cover part including an adjustment lever 70 according to an embodiment of the disclosure.

The case according to one or more embodiments of the disclosure in FIG. 9 may include the support part 42 and the cover part 43.

The cover part 43 may be configured with a first cover part 43a and a second cover part 43b. The first cover part 43a may cover a portion of the first bottom surface 42a and an upper side of the third bottom surface 42d. The second cover part 43b may cover the remaining portion of the first bottom surface 42a and an upper side of the second bottom surface 42c. In addition, the second cover part 43b may include a curved surface having a pre-set curvature.

According to still another example, the second cover part 43b may be in a form in which a portion thereof has a curved surface having a pre-set curvature, or still another portion being flat like the first cover part 43a.

Referring to FIG. 9, a portion of a center of the second cover part 43b may have a curved surface having a pre-set curvature, and the remaining two sides may be in a form flat like the first cover part 43a.

The first cover part 43a and the second cover part 43b may be integrated, or may be used with different materials from each other.

The second cover part 43b according to one or more embodiments of the disclosure in FIG. 9 may include an adjustment lever 70.

The adjustment lever 70 may be disposed on the curved surface of the second cover part 43b. In addition, the adjustment lever 70 may be disposed to be movable along the curved surface.

The adjustment lever 70 may further include a connection part (not shown). The sensor 41 may be connected with the adjustment lever 70 through the connection part. Through the above, the sensor 41 may adjust an angle integrally along a movement of the adjustment lever 70. The adjustable angle of the sensor 41 may be one from among the angle range of 60°±20° with respect to the panel 20. The user may adjust the angle in a method of grasping and moving the adjustment lever 70.

Meanwhile, the angle adjustment may be designed to be automatically performed. In this case, the ceiling-mounted air conditioner 100 may further include a motor (not shown) for adjusting the angle of the adjustment lever 70. The motor (not shown) may be connected with one side of the adjustment lever 70, rotate according to a control of the processor 51, and move the adjustment lever 70. According to the movement of the adjustment lever 70, the sensing angle of the sensor may be automatically adjusted.

Although not shown in FIG. 5, the sensor 41 may detect distance information data. In addition, the processor 51 may sense an indoor size through distance information detected through the sensor 41. The processor 51 may control the motor (not shown) based on the sensed indoor size, and adjust the angle of the sensor 41.

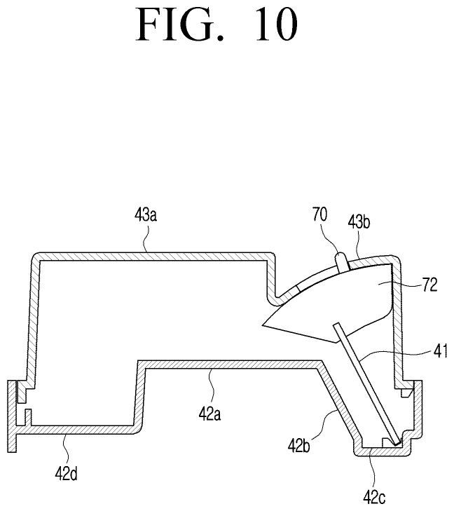

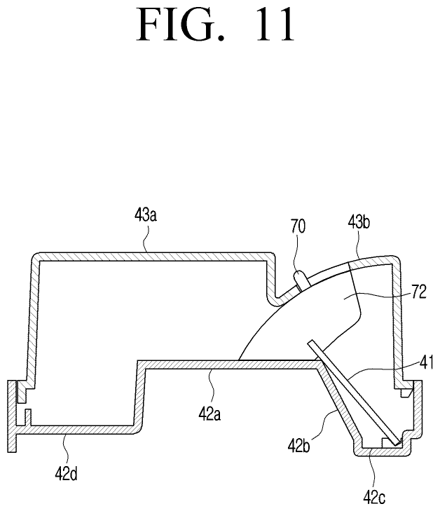

FIGS. 10 and 11 are diagrams illustrating a cross-section of the case in FIG. 9 taken along line A-A′ according to various embodiments of the disclosure.

Referring to FIGS. 10 and 11, a state in which the support part 42 and the cover part 43 are combined is shown. The structure as described may be referred to as a case. That is, the sensing part 40 may include a case for receiving the sensor 41. The case may include the support part 42 and the cover part 43, and the support part 42 may include the first bottom surface 42a, the seating surface 42b, the second bottom surface 42c, and the third bottom surface 42d. The cover part 43 may include the first cover part 43a and the second cover part 43b. The adjustment lever 70 may be disposed on the curved surface of the second cover part 43b. The adjustment lever 70 may move along the curved surface. Through the movement described above, a seating angle of the sensor may be adjusted.

According to one or more embodiments of the disclosure in FIGS. 10 and 11, an additional structure 72 may be further included.

The additional structure 72 may be connected with the adjustment lever 70 and disposed between the adjustment lever 70 and the sensor 41. A cross-section of the additional structure 72 may be fan-shaped. Specifically, an upper surface from the cross-section of the additional structure 72 may be in a shape same as the curved surface of the second cover part 43b. Accordingly, if the adjustment lever 70 moves to one side, the additional structure 72 may be moved together in a moving direction of the adjustment lever 70, and one side of the additional structure 72 may be first contacted with a bottom surface and rotation may be stopped.

Referring to FIG. 11, if the adjustment lever 70 is moved to a left side, a left side surface of the additional structure 72 may be contacted at the first bottom surface 42a and rotation may be stopped.

According to one or more embodiments of the disclosure in FIGS. 10 and 11, the additional structure 72 may be an elastomer. Specifically, the additional structure 72 may be of various materials such as, for example, and without limitation, rubber, silicon, polyurethane, and the like.

According to still another embodiment, the additional structure 72 may be of hard material such as plastic or aluminum.

Referring to FIGS. 10 and 11, the ceiling-mounted air conditioner 100 may adjust the sensor 41 to one from among the angle range of 60°±20° with respect to the panel 20 through the adjustment lever 70. Specifically, in FIG. 10, the sensor 41 may be in a state disposed at a maximum angle from among the angle range of 60°±20° with respect to the panel 20. In FIG. 11, the sensor 41 may be in a state disposed at a minimum angle from among the angle range of 60°±20° with respect to the panel 20.

For example, although not shown in FIG. 4, the processor 51 may detect indoor size data through the sensor 41. Based on the determined data, the processor 51 may adjust an angle of the sensor 41 to a minimum angle or a maximum angle from among the angle range of 60°±20° with respect to the panel 20 as shown in FIG. 11.

Specifically, the processor 51 may identify, based on a wall surface being sensed from data sensed while the sensor 41 is inclined at a maximum angle, a distance to the wall surface. If it is a 4-way ceiling-mounted air conditioner 100, a distance to the four surfaces may be identified in the same method. The 4-way ceiling-mounted air conditioner 100 may identify the distance to the surfaces in the same method. Thereby, the processor 51 may estimate a size of an indoor space or an installation position of the ceiling-mounted air conditioner 100. Based on the estimation result, if the ceiling-mounted air conditioner 100 is determined as positioned close to a first direction side surface, the processor 51 may adjust to also identify the human body at a relatively distant distance by setting an inclination of the sensor at the first direction side to a minimum angle, and setting an inclination of the sensor at the second direction side which is opposite to a maximum angle.

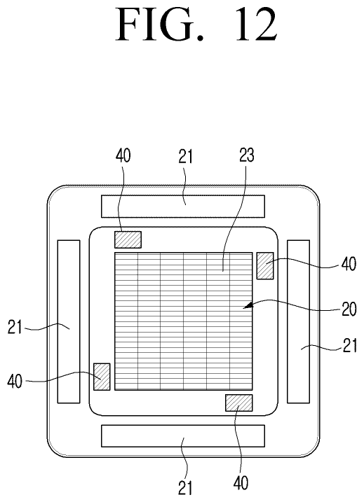

FIG. 12 is a diagram illustrating one surface of the 4-way type ceiling-mounted air conditioner 100 according to an embodiment of the disclosure.

Referring to FIG. 12, the ceiling-mounted air conditioner 100 may be the 4-way type ceiling-mounted air conditioner 100.

According to FIG. 12, the ceiling-mounted air conditioner 100 may include the plurality of discharge ports 21 disposed in four directions in total. Specifically, the plurality of discharge ports 21 may be formed in four directions different from one another on the panel 20.

In FIG. 12, the 4-way type ceiling-mounted air conditioner 100 may include the cabinet 10, the panel 20, the discharge port 21, the suction port 23, and the sensing part 40.

According to one or more embodiments of the disclosure in FIG. 12, the 4-way type ceiling-mounted air conditioner 100 may be disposed with one discharge port 21 for every north, south, east, and west directions. The 4-way type ceiling-mounted air conditioner 100 may include one sensing part 40 for every north, south, east, and west directions.

In the 4-way type ceiling-mounted air conditioner 100, the sensing part 40 may be disposed respectively for each discharge port direction. Because the sensing part 40 is disposed respectively for each discharge port direction, human bodies moving in all directions may be fluidly sensed.

The processor 51 may control, based on receiving detection of human body sensing data through the sensing part 40 from one direction of the four directions, the driving part 55 based therefrom. The processor 51 may adjust wind strength, and the like for each discharge port through the control of the driving part 55. For example, if a human body is sensed from a south side, the processor 51 may control the driving part and discharge wind strongly from the south discharge port 21, and stop or discharge wind weakly from a different discharge port 21.

In FIG. 12, the plurality of sensing parts 40 may be disposed at an inner side of the panel 20. The plurality of sensing parts 40 may measure at least one of distance data from each direction, speed data, angle data, or biometric signal data.

The processor 51 may sense whether or not there is a human body based on sensing values measured from the plurality of sensing parts 40. The processor 51 may control the ceiling-mounted air conditioner 100 for the ceiling-mounted air conditioner 100 to operate in at least one operation mode from among at least one of the cooling operation mode, the dehumidifying operation mode, or the purifying operation mode based on the sensed information.

In FIG. 12, the plurality of sensing parts 40 may include the sensor 41 inclined at the pre-set angle toward an outside direction of the plurality of discharge ports 21 with respect to the center of the panel 20.

The processor 51 may sense whether there is a human body based on sensing values measured from the sensor 41 included in the plurality of sensing parts 40.

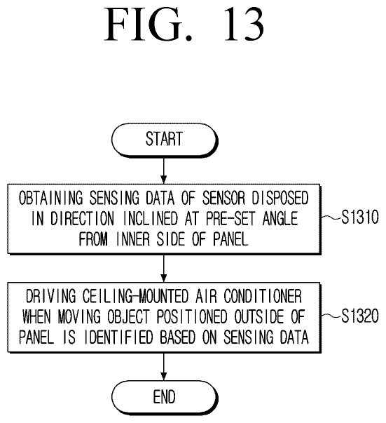

FIG. 13 is a flowchart illustrating a control method of the ceiling-mounted air conditioner 100 according to an embodiment of the disclosure.

Referring to FIG. 13, a control method of the ceiling-mounted air conditioner 100 may include obtaining sensing data of the sensor 41 disposed in the direction inclined at the pre-set angle from the inner side of the panel 20 which is disposed at one surface of the cabinet 10 at operation S1310.

In addition, the control method of the ceiling-mounted air conditioner 100 may include driving the ceiling-mounted air conditioner 100 when a moving object positioned outside of the panel 20 is identified based on the obtained sensing data at operation S1320.

According to at least one embodiment of the disclosure in FIG. 13, the pre-set sensing angle of the sensor 41 may be adjusted within the angle range of 60°±20° with respect to the panel 20. The pre-set sensing angle of the sensor 41 may be adjusted manually, or may be adjusted automatically through the motor (not shown). Specifically, the user 80 may directly adjust the sensing angle of the sensor 41 within the angle range of 60°±20° with respect to the panel 20. Accordingly, sensing efficiency of the sensor 41 may be improved according to a size of a room, characteristics of the user 80, and the like.

According to still another embodiment of the disclosure in FIG. 13, the ceiling-mounted air conditioner 100 may further include the plurality of discharge ports 21 formed in four directions different from one another, and the sensors 41 may be disposed respectively for each of the plurality of discharge ports 21. Based on the configuration described above, the driving the ceiling-mounted air conditioner 100 may include discharging air to at least one discharge port 21 when a moving object is identified from the direction of at least one discharge port 21 from among the plurality of discharge ports 21.

According to at least one embodiment of the disclosure, the processor 51 may estimate a movement of the user 80 through the plurality of sensors 41. Accordingly, the processor 51 may discharge air to the discharge port 21 corresponding to a position at which the user is to reach in advance. The processor 51 may control the driving part 55 to discharge air through the plurality of discharge ports 21.

The ceiling-mounted air conditioner 100 according to various embodiments may be a device that performs functions such as air purification, ventilation, humidity control, cooling, heating, or the like, in an air conditioned space (hereinafter, referred to as “indoors”), and may mean a device provided with at least one from among the functions described above.

Each of the elements described in the disclosure may be configured with one or more components, and designations of the corresponding elements may vary according to the type of the electronic device.

In the above, various embodiments of the disclosure have been described individually, but each of the embodiments may not necessarily be implemented on its own, and the configuration and operation of each of the embodiments may be implemented in combination with at least one other embodiment.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A ceiling-mounted air conditioner, comprising:
a cabinet;
a panel disposed at one surface of the cabinet; and
a sensing part disposed at an inner side of the panel,
wherein the sensing part comprises:
a sensor configured to sense an object positioned outside of the panel, and
a case for receiving the sensor, and
wherein the case comprises:
a support part supporting the sensor for the sensor to perform sensing in a direction inclined at a pre-set angle with respect to the panel, and
a cover part covering the sensor by coupling with the support part.

2. The ceiling-mounted air conditioner of claim 1, further comprising:
memory storing instructions; and
one or more processors communicatively coupled to the memory,
wherein the instructions, when executed by the one or more processors individually or collectively, cause the ceiling-mounted air conditioner to:
control, based on the object positioned outside of the panel being sensed based on a sensing result of the sensor, an operation of the ceiling-mounted air conditioner.

3. The ceiling-mounted air conditioner of claim 2, wherein the sensor is a radar sensor.

4. The ceiling-mounted air conditioner of claim 2, wherein operation of the ceiling-mounted air conditioner includes at least one of a cooling operation, a dehumidifying operation, or a purifying operation mode.

5. The ceiling-mounted air conditioner of claim 2,
wherein the support part comprises:
a first bottom surface,
a seating surface formed to be inclined at the pre-set angle from the first bottom surface to one side, and
a second bottom surface protruded from the seating surface, and
wherein the sensor is seated at the seating surface while one side is supported by the second bottom surface.

6. The ceiling-mounted air conditioner of claim 5,
wherein the support part further comprises a third bottom surface formed at a height different from the first bottom surface and the second bottom surface at a side of the support part that is opposite to the second bottom surface with respect to the first bottom surface,
wherein the cover part comprises:
a first cover part for covering a portion of the first bottom surface and an upper side of the third bottom surface, and
a second cover part which is connected with the first cover part, and which is for covering a remaining portion of the first bottom surface and an upper side of the second bottom surface, and
wherein the second cover part comprises a curved surface having a pre-set curvature.

7. The ceiling-mounted air conditioner of claim 6, wherein the first bottom surface is disposed to be parallel with the panel.

8. The ceiling-mounted air conditioner of claim 1, wherein the pre-set angle is one from among an angle range of 60°±20° with respect to the panel.

9. The ceiling-mounted air conditioner of claim 7,
wherein the case further comprises an adjustment lever disposed to be movable along the curved surface on the curved surface of the second cover part,
wherein the adjustment lever is connected with the sensor, and
wherein an angle of the sensor is adjustable according to movement of the adjustment lever.

10. The ceiling-mounted air conditioner of claim 9, further comprising:
an additional structure connecting the adjustment lever and the sensor,
wherein the additional structure is an elastomer.

11. The ceiling-mounted air conditioner of claim 5,
wherein the case further comprises:
a connection part connected with the sensor on the second bottom surface, and
a motor for adjusting an angle of the connection part, and
wherein the instructions, when executed by the one or more processors individually or collectively, further cause the ceiling-mounted air conditioner to:
change a sensing angle of the sensor by controlling the motor to adjust the angle of the connection part.

12. The ceiling-mounted air conditioner of claim 1, further comprising:
a plurality of discharge ports formed in four different directions different from one another from the panel,
wherein the sensing part comprises a plurality of sensing parts which is respectively disposed for each of the plurality of discharge ports, and
wherein the each of the plurality of sensing parts comprises a sensor inclined at the pre-set angle toward an outer direction of the plurality of discharge ports with respect to a center of the panel.

13. The ceiling-mounted air conditioner of claim 1, wherein the sensor is configured to measure at least one of distance data, speed data, angle data, or biometric signal data.

14. A method performed by a ceiling-mounted air conditioner, the method comprising:
obtaining sensing data of a sensor disposed in a direction inclined at a pre-set angle from an inner side of a panel disposed at one surface of a cabinet of the ceiling-mounted air conditioner; and
driving, based on the sensing data, the ceiling-mounted air conditioner when a moving object positioned outside of the panel is identified.

15. The method of claim 14, wherein a sensing angle of the sensor is adjustable in an angle range of 60°±20° with respect to the panel.

16. The method of claim 14, further comprising:
adjusting a sensing angle of the sensor in an angle range of 60°±20° with respect to the panel according to user operation.

17. The method of claim 16, wherein the sensing angle of the sensor is adjusted based on movement of an adjustment lever by a motor.

18. The method of claim 14,
wherein the ceiling-mounted air conditioner further comprises a plurality of discharge ports formed in four different directions different from one another from the panel,
wherein the sensor comprises a plurality of sensors disposed respectively for each of the plurality of discharge ports, and
wherein the driving the ceiling-mounted air conditioner comprises discharging, based on the moving object being identified from a direction of at least one discharge port from among the plurality of discharge ports, air to the at least one discharge port.

19. The method of claim 14, wherein the ceiling-mounted air conditioner is driven to perform at least one of a cooling operation, a dehumidifying operation, or a purifying operation mode, based on the sensing data.

20. The method of claim 14, wherein the sensor is configured to measure at least one of distance data, speed data, angle data, or biometric signal data.
